(19) United States
(12) Patent Application Publication
(10) Pub. No.: US 2012/0100004 A1
(43) Pub. Date: Apr. 26, 2012

(54) High efficiency impeller

(76) Inventor: Steven J. McClellan, Nashua, NH (US)

(21) Appl. No.: 12/911,307

(22) Filed: Oct. 25, 2010

(51) Int. Cl. F03B 3/12; B23P 15/02

(52) U.S. Cl. 416/241 R; 29/889.7

(57) ABSTRACT

An impeller for a turbine includes a conical body having a wider end, a narrower end and an outside surface, a front end surface connected to the wider end of the conical body, a back end surface connected to the narrower end of the conical body, and a plurality of helical grooves disposed in the outside surface of the conical body wherein the helical grooves decrease in depth from the wider end to zero depth near the narrower end.

### BACKGROUND OF THE INVENTION

1. Field of the Invention

The present invention relates generally to generation of electrical power utilizing fluids. Particularly, the present invention relates to impellers used for generating electricity.

2. Description of the Prior Art

With the increasing need for electrical power production and the decreasing availability of non-renewable fossil fuels, alternative sources of energy must be developed. Fossil fuels currently make up a major portion of the fuels used to produce electricity.

For over two thousand years, mankind has known and harnessed kinetic energy in flowing water to perform mechanical endeavors. The advent of the turbine in the first half of the nineteenth century culminated in the present advancements in hydroelectric power generation. The interest and innovation in hydroelectric power generation peaked in the first quarter of the twentieth century. Since then, fossil fuels have dominated as the high net energy and available energy source in the production of electricity and other conveyors of power.

Wind generation of electricity is also not a new idea. Some believe the first wind generator was created around 1891 to generate hydrogen for the gaslights in schools. Since that time, a tremendous amount of engineering and development has gone into wind generators.

For hydroelectric power generation, auger-shaped turbines for converting the natural energy of moving bodies of water such as rivers, waterfalls, channels, and the like are known to exist. Such systems transfer rotary motion of the turbine to an electrical generator for converting energy from the flowing stream into electrical power. Auger-type turbines are used for harnessing the natural energy of either single or bi-directional river flows. In addition, other pressurized fluids such as gas, steam, etc., to rotate a generator are known. With large hydroelectric power generation operated with a large-scale water source such as a river or dam, thousands of megawatts of power may be generated using millions of gallons of flowing water. As such, conversion of the kinetic energy in the flowing water to electric power may include significant inefficiencies and yet still provide an economical and acceptable level of performance.

As the size of the hydroelectric power generation equipment becomes smaller, the magnitude of electric power produced also becomes smaller. In addition, the amount of flowing water from which kinetic energy may be extracted becomes less. Thus, efficiency of the conversion of the kinetic energy in the flow of water to electric power becomes significant. When there are too many inefficiencies, only small amounts of kinetic energy is extracted from the pressurized flowing water. As a result, the amount of electric power produced diminishes as the size of the hydro-electric power generation equipment becomes smaller.

A unidirectional turbine is a turbine capable of providing unidirectional rotation from bidirectional or reversible fluid flow, such as in tidal estuaries or from shifting wind directions. Generally, three basic types of unidirectional reaction turbines are known, the Wells turbine, the McCormick turbine, and the Darrieus turbine. The Wells reaction turbine is a propeller-type turbine that includes a series of rectangular airfoil-shaped blades arranged concentrically to extend from a rotatable shaft. Typically, the turbine is mounted within a channel that directs the fluid flow linearly along the axis of the rotatable shaft. The blades are mounted to extend radially from the rotatable shaft and rotate in a plane perpendicular to the direction of fluid flow. Regardless of the direction in which the fluid flows, the blades rotate in the direction of the leading edge of the airfoils. The Wells turbine is capable of rapid rotation. The outer ends of its blades move substantially faster than the flowing air, causing high noise. Also, its efficiency is relatively low, because the effective surface area of the airfoil-shaped blades is limited to the outer tips, where the linear velocity is greatest. The blades cannot capture a substantial amount of the available energy in the fluid flowing closer to the shaft.

The McCormick turbine includes a series of V-shaped rotor blades mounted concentrically between two series of stator blades. The rotor blades are mounted for rotation in a plane perpendicular to the direction of fluid flow. The stator blades direct fluid flow to the rotor blades. To achieve unidirectional rotation with bidirectional fluid flow, the outer stator blades are open to fluid flowing from one direction, while the inner stator blades are open to fluid flowing from the opposite direction. The McCormick turbine is quieter and could be more efficient than the Wells turbine. Its rotational speed, however, is too slow for direct operation of an electric generator. Its configuration is also complex and expensive to manufacture.

The Darrieus machine is a reaction turbine with straight airfoil-shaped blades oriented transversely to the fluid flow and parallel to the axis of rotation. The blades may be attached to the axis by circumferential end plates, struts, or by other known means. In some variations, the blades are curved to attach to the ends of the axis. A Darrieus reaction turbine having straight rectangular blades, mounted vertically or horizontally in a rectangular channel, has been placed directly in a flowing body of water to harness hydropower. The Darrieus turbine rotates with a strong pulsation due to accelerations of its blades passing through the higher pressure zones in the fluid, which lowers the efficiency of the turbine.

Therefore, what is needed is an efficient, uniformly rotational, simple, unidirectional turbine that can operate at high speeds and higher efficiency.

### SUMMARY OF THE INVENTION

It is an object of the present invention to provide an efficient, uniformly rotational, simple, unidirectional turbine impeller that can operate at high speeds. It is another object of the present invention to provide a turbine impeller that captures a substantial amount of the available energy in the fluid interacting with the impeller. It is a further object of the invention to minimize cavitation as the impeller's speed increases. It is still another object of the invention to provide an impeller having less resistance on rotation.

The present invention achieves these and other objectives by providing in one embodiment an impeller having a conical body and a plurality of helical grooves disposed in the outside surface of the conical body where the helical grooves decrease in depth from the wider end or head of the conical body to zero depth near the narrower end or tail of the conical body.

In another embodiment of the present invention, the impeller includes an optional tooth at the wider end or head of the conical body that extends forwardly from each of the plurality of helical grooves.

In a further embodiment of the present invention, the plurality of helical grooves extends uniformly in a counterclockwise direction or a clockwise direction from the wider end or head to the narrower end or tail of the conical body.

In still another embodiment of the present invention, the cross-sectional shape of the plurality of helical grooves is elliptical.

In yet another embodiment of the present invention, each of the plurality of helical grooves has a forward edge and a trailing edge where a helical groove surface of the helical groove adjacent the forward edge is more concave than the helical groove surface of the helical groove adjacent the forward edge. For clarity, the forward edge of the helical groove is defined as the first edge of the groove that is encountered by a line transverse to the longitudinal axis of the conical body when the conical body is rotating relative to its longitudinal axis.

In another embodiment of the present invention, the impeller has a front end at the wider end or head of the conical body and a back end at the narrower end or tail of the conical body where each of the front end and the back end have a mounting structure capable of permitting longitudinal, rotational movement of the conical body.

In a further embodiment of the present invention, the front end has a tapered conical surface that extends forward from the interface between the wider end or head of the conical body to a narrower front end a predefined distance forward from the wider end or head of the conical body.

In another embodiment of the present invention, the front end has a convex spherical surface that has a depth or length in the range greater than a flat planar surface and less than or equal to a hemisphere.

In another embodiment of the present invention, the back end has a tapered conical surface that extends forward from the interface between the narrower end or tail of the conical body to a narrower back end a predefined distance rearward from the narrower end of the conical body.

In another embodiment of the present invention, the back end has a convex spherical surface that has a depth or length in the range greater than a flat planar surface and less than or equal to a hemisphere.

In still another embodiment of the present invention, the impeller is housed in a cylindrical housing. The cylindrical housing will provide less turbulence to the exiting fluid due to the larger volume present in the cylindrical housing at the narrower end of the conical body of the impeller. The disadvantage is a slight lessening in the use of the fluid's kinetic energy.

In yet another embodiment of the present invention, the impeller is housed in a conical housing. The conical housing will force the capture of more of the kinetic energy of the fluid flow than the cylindrical housing but at the expense of a slight increase in turbulence effect.

In all embodiments of the present invention, the impeller is a high speed impeller that has the advantage of using more kinetic energy of the fluid flowing past the impeller to produce a relatively greater amount of potential energy than conventional impellers. Because of the shape of the present invention, the impeller will spin faster than blade and foil impellers. This is due to the continuous impingement of the fluid onto the helical surface of the grooves over the entire length of the grooves. As the fluid enters the helical grooves, the kinetic energy of the fluid continuously engages the curving helical surface of the grooves causing the impeller to spin. This action occurs as the fluid continues to move along the entire length of the helical groove.

To further enhance the effect of the helical grooves, the helical grooves may optionally be made such that the cross-sectional shape of the groove is an ellipse. Where the helical grooves are open along the surface of the conical body, each helical groove has a forward edge and a trailing edge relative to the spinning rotation of the conical body. For example, when the plurality of helical grooves wrap around the conical body in a counterclockwise direction, the spinning rotation of the conical body caused by a fluid flow as viewed from the wider, front end would be clockwise. Conversely, when the plurality of helical grooves wrap around the conical body in a clockwise direction, the spinning rotation of the conical body would be in a counterclock direction. The elliptically-shaped grooves are preferably oriented so that the helical surface of the leading edge is more concave than the helical surface of the trailing edge. The greater concavity of the leading edge presents a greater surface area of the groove to the fluid thus capturing a greater amount of kinetic energy than helical grooves that have a round or circular cross-sectional shape.

Another advantage of the present invention is its low fluid dissipation factor. The conical shape of the body of the impeller coupled with the decreasing depth of the plurality of helical grooves as the grooves extend from the wider end of the conical body to the narrower end lessens the turbulence effect and reduces the likelihood of fluid cavitation that occurs with auger or propeller-shaped impellers as they turn faster in the fluid stream. Less turbulence and cavitation of the fluid stream means that the impeller of the present invention has less environmental impact. It is contemplated that the length of the body of the impeller from the head to the tail may vary, the number of turns of the helical groove may vary depending on the applications, the number of helical grooves may vary, and the taper angle from head to tail of the impeller body may also vary, depending on the application.

The present invention can be used in turbines where the fluid source are dams, rivers, vortex mechanisms, pipe flow, tidal flow, wind, and any moving fluid as well as in home and commercial closed systems.

### BRIEF DESCRIPTION OF THE DRAWINGS

FIG. 1 is a perspective view of one embodiment of the present invention showing the conical-shaped impeller.

FIG. 2 is a side view of the embodiment shown in FIG. 1.

FIG. 3 is a front view of the embodiment in FIG. 1 showing the wider end or head of the impeller.

FIG. 4 is a rear view of the embodiment in FIG. 1 showing the narrower end or tail of the impeller.

FIG. 5 is a perspective transparent view of the embodiment of the present invention showing the helical grooves in the surface of the conical-shaped impeller.

FIG. 6 is a side view of one embodiment of the front end of the conical-shaped impeller showing a bore for receiving a mounting structure.

FIG. 7 is a side view of one embodiment of the back end of the conical-shaped impeller showing a bore for receiving a mounting structure.

FIG. 8 is a perspective, cut-away view of another embodiment of the present invention showing the impeller inside a cylindrical housing.

FIG. 9 is a perspective, cut-away view of another embodiment of the present invention showing the impeller inside a conical-shaped housing.

FIG. 10 is a partial side view of the helical grooves of the present invention showing the changing depth of the helical groove from the wider end to the narrower end of the conical body.

FIG. 11 is an enlarged, cross-sectional view of one embodiment of the helical groove of the present invention showing a helical groove with an elliptical shape.

### DETAILED DESCRIPTION OF THE PREFERRED EMBODIMENT

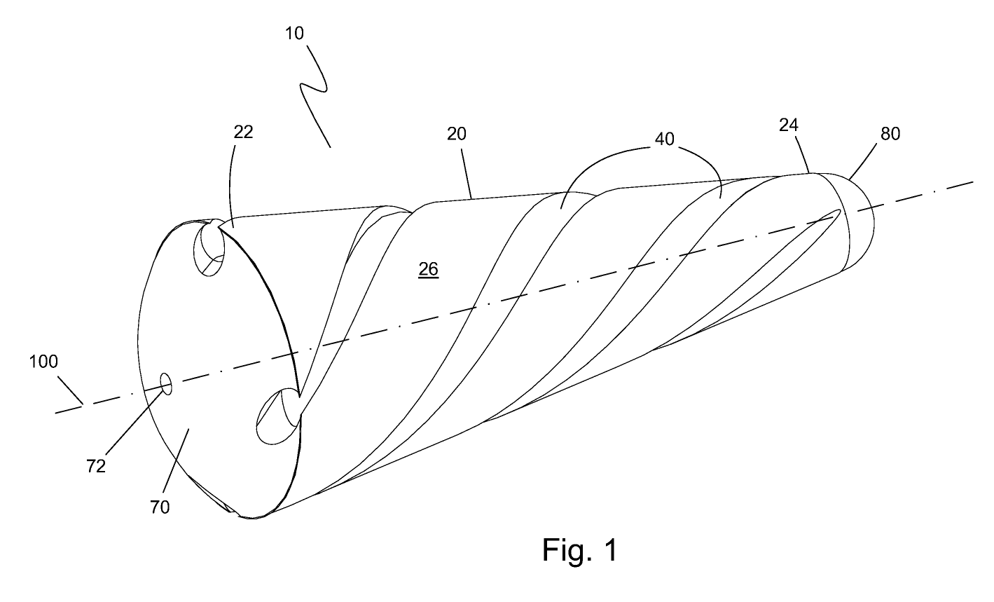

The preferred embodiment(s) of the present invention is illustrated in FIGS. 1-11. FIG. 1 illustrates one embodiment of an impeller 10 of the present invention. Impeller 10 includes a conical body 20 and a plurality of helical grooves 40. Conical body 20 has a wider end 22, a narrower end 24 and an outside surface 26. Outside surface 26 is preferably smooth. Impeller 10 optionally includes a front end 70 and a back end 80. Conical body 20 is designed to rotate about longitudinal axis 100.

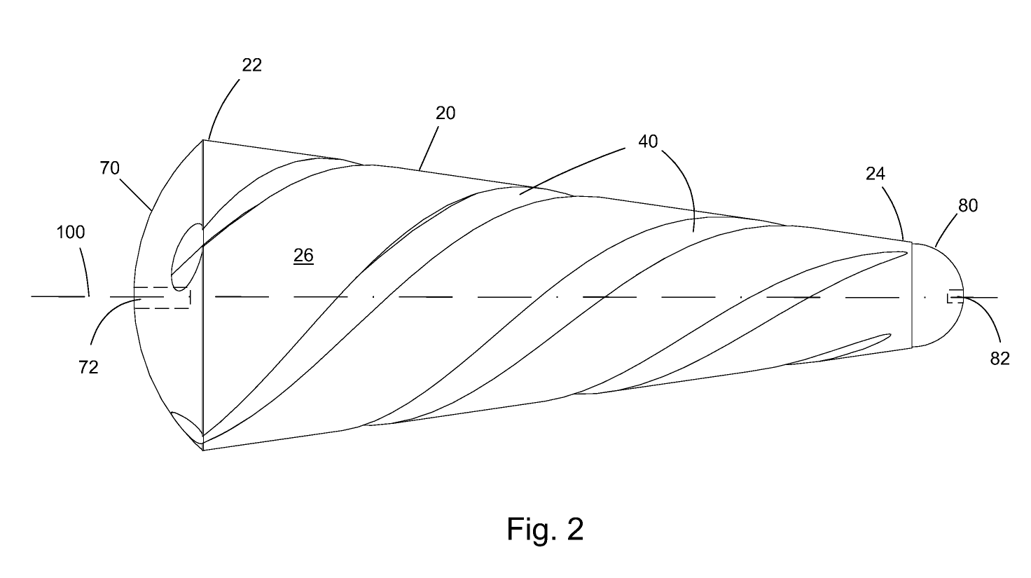

FIG. 2 illustrates a side view of the embodiment in FIG. 1. Conical body 20 tapers from wider end 22 to narrower end 24 in a preferred ratio of about 2.5 units to 1 unit over a distance of about 5 units to 1 unit relative to the narrower end. For example, if wider end 22 has a diameter of about 9 units, then narrower end 24 has a diameter of about 3.5 units and the length of conical body 20 would be about 16 units. Front end 70 has a mounting structure 72, which is in this example a bore hole for receiving a bearing, axle, or other rotational structure that allows conical body 20 to rotate around the longitudinal axis 100 of conical body 20. Mounting structure 72 preferably is a bore hole with a diameter of about one unit relative to the units describing the conical body 20 and a depth of about 1 to 2 units into front end 70. It should be understood that mounting structure 72 may optionally be a fixed structure mounted to front end 70 with the fixed structure being rotationally connected to another support structure to permit free rotation of conical body 20. It is contemplated that the taper angle of the body, the number of helical grooves, the number of turns per unit of length of the helical groove, and the length of the body of the impeller may vary according to the application for which the impeller is used.

Back end 80 also has a mounting structure 82 similar to mounting structure 72. In this example, mounting structure 82 is preferably a bore hole with a diameter of about 0.5 units to about 1 unit relative to the units describing the conical body 20 and a depth of about 1 to 2 units into back end 80. Like mounting structure 72, it should be understood that mounting structure 82 may optionally be a fixed structure mounted to back end 80 with the fixed structure being rotationally connected to another support structure to permit free rotation of conical body 20. It is contemplated that front end 70 and back end 80 may be a uniform structure with conical body 20 or separate components that are integrally connected to wider end 22 and narrower end 24, respectively, of conical body 20, or removably connectable to wider end 22 and narrower end 24, respectively.

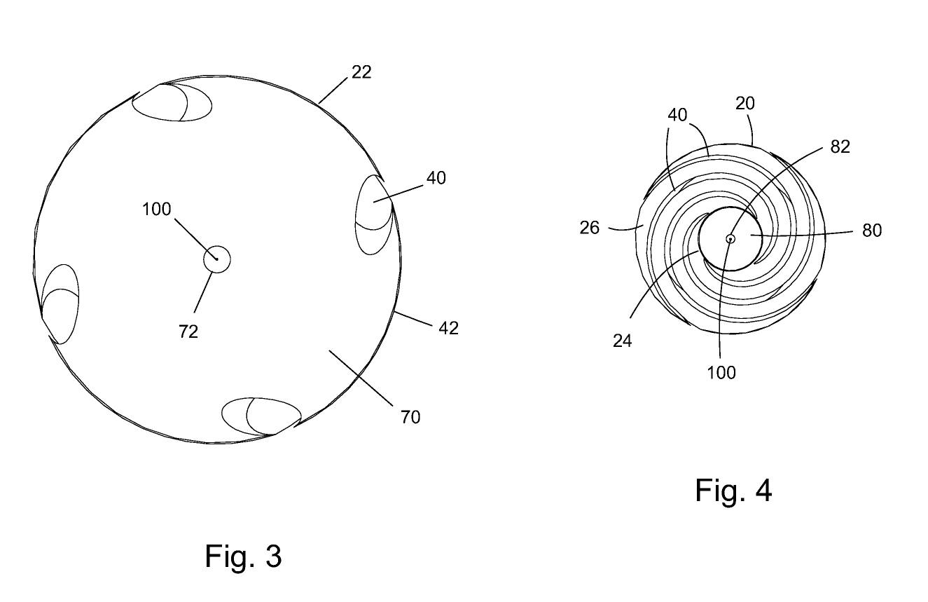

Turning now to FIG. 3, there is shown a front view of impeller 10. Front end 70 has mounting structure 72 in the center and mounting structure 72 is concentric with longitudinal axis 100 of conical body 20. The plurality of helical grooves 40 begin at wider end 22 where substantially the entire diameter of each helical groove is formed in the outer surface 26 and the circumferential edge 42 of helical groove 40 is substantially at the outer surface 26. At the junction of circumferential edge 42 and integrally connected either to outer surface 26 or the periphery of front end 70 is a tooth 60 that extends forwardly from wider end 22 of conical body 20 at the opening of helical groove 40. Each of the helical grooves 40 preferably has a tooth 60 that aids in providing a “biting” tooth against the fluid that impinges against front end 70. Tooth 60 is preferably curved with the curved surface forming a arc whose diameter is substantially similar to at least the diameter of wider end 22 of conical body 20 but may also be similar to the curvature of helical groove 40.

FIG. 4 is a back end view of impeller 10. Back end 80 has a mounting structure 82 in the center and mounting structure 82 is also concentric with longitudinal axis 100 of conical body 20. The plurality of helical grooves 40 end adjacent to narrower end 24. More specifically, helical grooves 40 merge into outside surface 26, which is a consequence of the depth of each of the plurality of helical grooves 40 become shallower relative to the outside surface 26 from wider end 22 to narrower end 24. In this view, it can be seen that impeller 10 has four helical grooves. It should be understood that conical body 20 may have any number of helical grooves 40 but that it is preferable to have three to six helical grooves. In this embodiment, helical grooves rotate counterclockwise along the length of conical body 20 from front end 70. It should be understood, however, that the helical grooves may optionally rotate clockwise along the length of conical body 20 from front end 70.

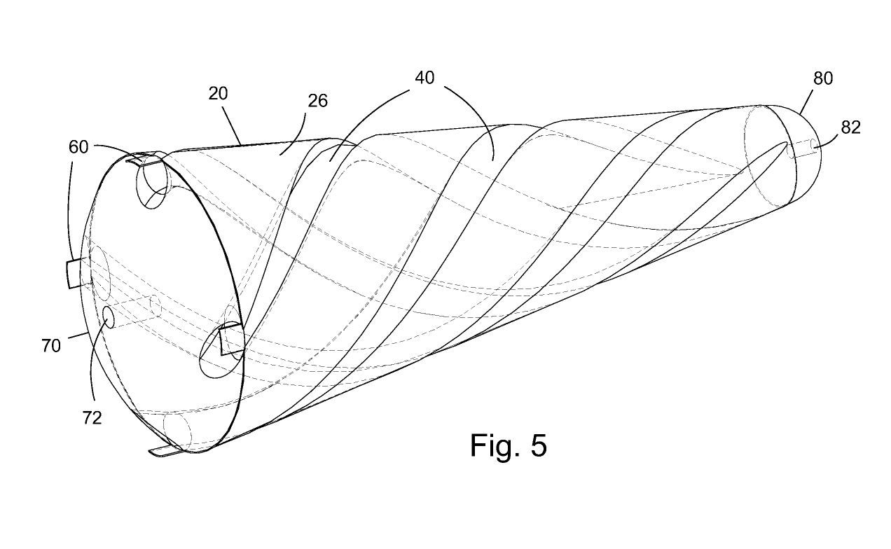

Turning now to FIG. 5, there is illustrated a perspective, transparent view of impeller 10. The transparent view shows the plurality of helical grooves 40 in the outside surface 26 of conical body 20 as they extend from the wider end 22 to the narrower end 24. In this embodiment, the plurality of helical grooves 40 extends in a counterclockwise direction from wider end 22. As stated previously, the plurality of helical grooves 40 may alternatively extend in a clockwise direction from wider end 22. Although each helical groove 40 shown extends through only about 0.8 rotations, it is contemplated that each helical groove 40 may extend through as many as five or less rotations. The preferred rotation is approximately 1.5 rotations. It is further contemplated that the number of helical grooves 40 may be three to eight helical grooves. Front end 70 shows mounting structure 72 as extending a predefined depth into the front end 70. Similarly, back end 80 shows mounting structure 82 also extending a predefined depth into back end 80. Each of the helical grooves 40 may optionally have a tooth 60 that aids in providing a “biting” tooth against the fluid that impinges against front end 70. Tooth 60 is preferably curved with the curved surface forming an arc whose diameter is substantially similar to at least the diameter of wider end 22 of conical body 20 but may also be similar to the curvature of helical groove 40. Tooth 60 may be only a ridge at the helical groove 40 opening or may be a structure that extends forwardly from the edge of the helical groove 40. It is contemplated that tooth 60 aids in directing the fluid into helical groove 40 as the fluid impinges against front end 70. The size, shape and position of tooth 60 relative to the helical groove 40 is determined by the application for which impeller 10 will be used as well as the need to balance any improvement in rotational efficiency with the resistance the tooth 60 adds to the spinning impeller 10.

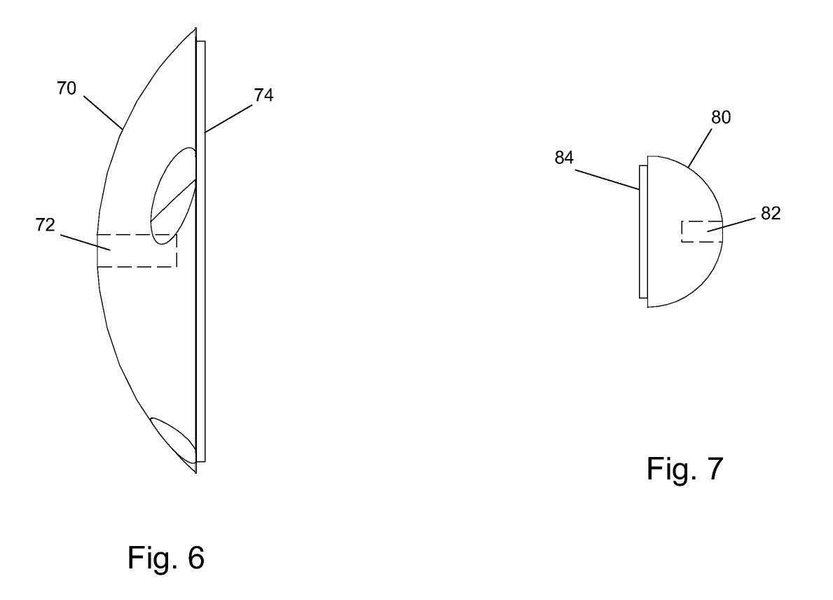

FIG. 6 illustrates a side view of one embodiment of front end 70. Front end 70 has front mounting structure 72, which may be adapted for receiving an axle, a bearing and axle, a fixed rod to which the rod is rotatably mountable to another supporting structure, or any structure that rotationally supports impeller 10. It is contemplated that front mounting structure 72 may be any structure that, when impeller 10 is fully assembled for its intended purpose, impeller 10 can freely rotate about the impeller's longitudinal axis. Front end 70 may also include a mating interface 74 for joining to wider end 22 of conical body 20. Although not shown, it should be understood that fluid directing tooth 60 may be integrally connected to either wider end 22 or to frond end 70 at the periphery adjacent the openings 41 of helical grooves 40.

FIG. 7 illustrates a side view of one embodiment of back end 80. Back end 80 has a back mounting structure 82, which may be adapted for receiving an axle, a bearing and axle, a fixed rod to which the rod is rotatably mountable to another supporting structure. Back end 70 may also include a mating interface 84 for joining to narrower end 24 of conical body 20. Like the front mounting structure 72, it is contemplated that back mounting structure 82 may be any structure that, when impeller 10 is fully assembled for its intended purpose, impeller 10 can freely rotate about the impeller's longitudinal axis.

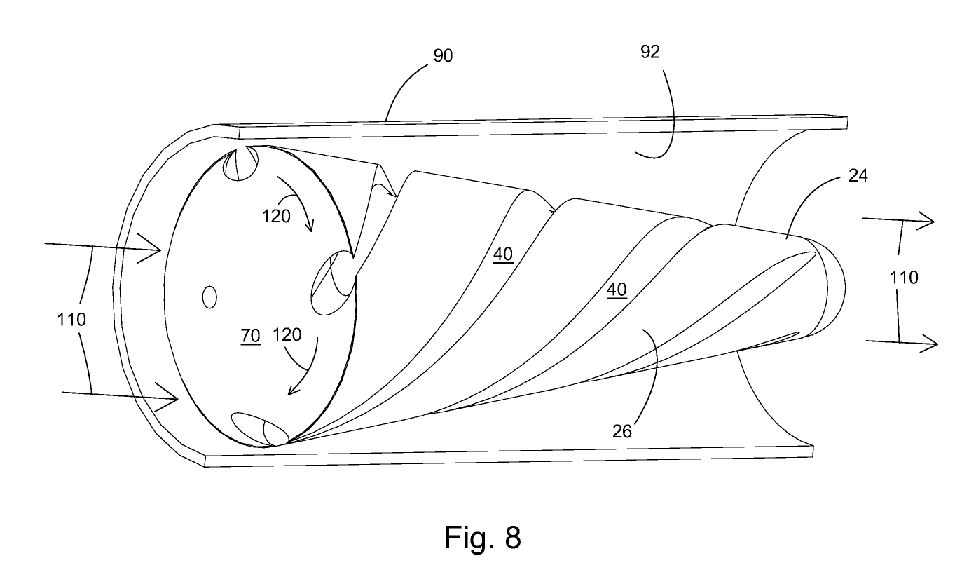

FIG. 8 discloses another embodiment of the present invention. In this illustration, impeller 10 is contained within an optional housing 90. In this embodiment, optional housing 90 has an inside surface 92 that is cylindrically shaped. Arrows 110 indicate the direction of fluid flow. As can be seen, fluid impinges onto front end 70 and into each of the plurality of helical grooves 40. Because the plurality of helical grooves 40 extend in a counterclockwise direction along outer surface 26 of conical body 20, the fluid flow will cause impeller 10 to spin clockwise as shown by arrow 120. The cylindrical inside surface 92 and the taper of the conical body 20 coupled with the decreasing depth of the helical groove 40 decreases the amount of fluid turbulence that exits housing 90 at narrower end 24.

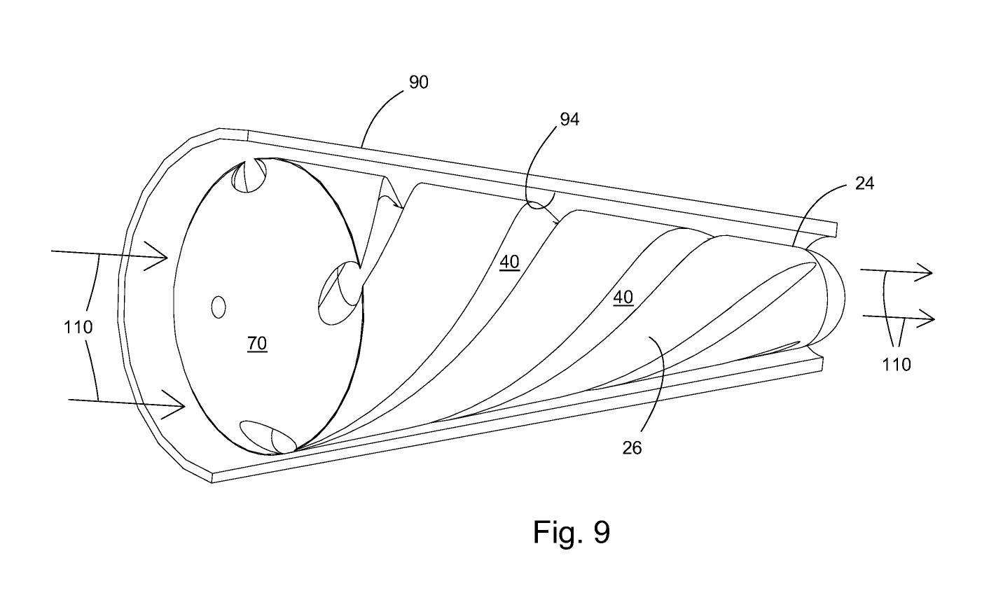

FIG. 9 discloses another embodiment of the present invention. In this illustration, impeller 10 is contained within an optional housing 90, which has an inside surface 94 that is conically shaped. Like in FIG. 8, arrows 110 indicate the direction of fluid flow and the fluid impinges onto front end 70 and into each of the plurality of helical grooves 40. The conical inside surface 94 and the taper of the conical body 20 coupled with the decreasing depth of the helical groove 40 decreases the amount of fluid turbulence that exits housing 90 at narrower end 24. Although housing 90 in this embodiment is shown as having a cone shape, it should be understood that the housing may have any external shape while the inside surface 94 is conically shaped.

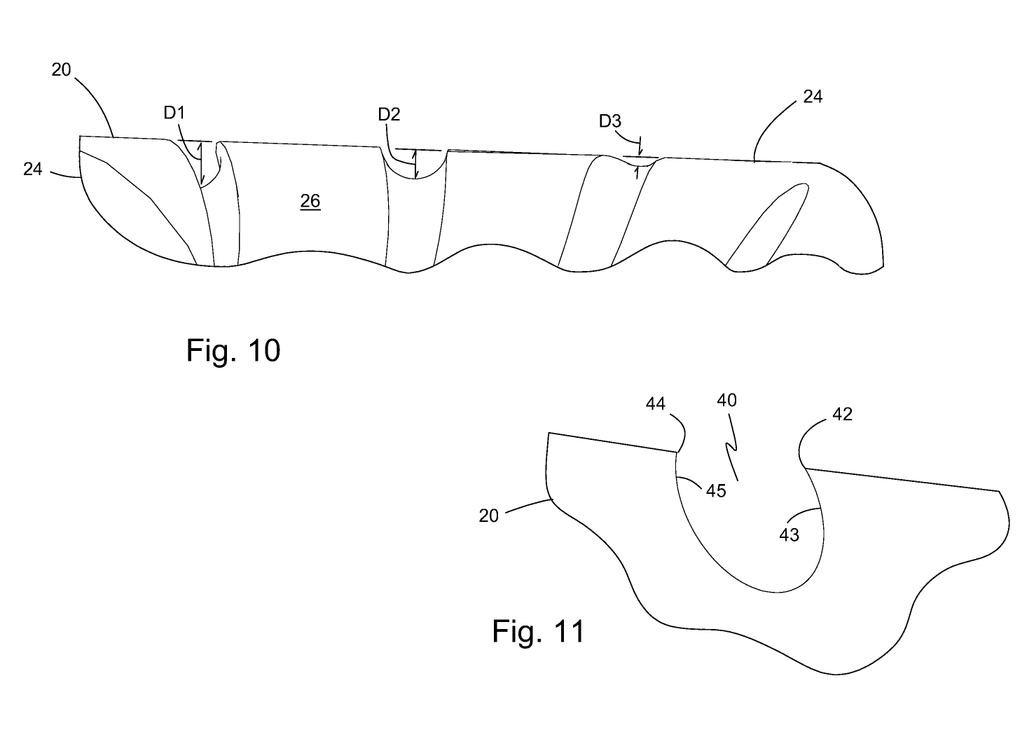

FIG. 10 is a partial side view of the helical grooves 40. As shown, the depth D1 of helical groove 40 into outer surface 26 of conical body 20 is greater than the depth D2 of helical groove 40 that is further away from front end 70. It is further shown that the depth of D2 is greater than the depth of D3 of helical groove 40 that is further away from front end 70. This clearly illustrates the characteristic of each of the plurality of helical grooves 40 where the depth of each helical groove decreases as the helical groove extends from wider end 22 to narrower end 24. At or adjacent narrower end 24, the helical groove ends tangent to or flush with the outer surface 26 of conical body 20.

FIG. 11 is a cross-sectional view of one embodiment of the helical groove 40. In this embodiment, there is illustrated a cross-section of an exaggerated, elliptical groove to show the difference between the contour of an inside surface 43 of helical groove 40 adjacent a forward edge 42 and the contour of an inside surface 45 adjacent a trailing edge 44 of helical groove 40 previously disclosed. Inside surface 43 of forward edge 42 has a concavity that is greater than the inside surface 45 of trailing edge 44. The greater concavity of inside surface 43 presents a larger surface area upon which the fluid impinges against for transferring the kinetic energy in the fluid to the conical body 20 of impeller 10 causing the impeller 10 to spin faster. Further, since the fluid flow continues to impinge the inside surface 43 as it moves along the helical groove 40 (effectively impinging a greater surface area of impeller 10 than the surface area of those impellers with vanes), the greater the amount of kinetic energy contained by the fluid is transferred to the conical body 20 inducing it to spin more quickly.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An impeller comprising:
a conical body having a wider end, a narrower end and an outside body surface;
a front end surface connected to the wider end of the conical body;
a back end surface connected to the narrower end of the conical body; and
a plurality of helical grooves disposed in the outside surface of the conical body wherein the helical grooves decrease in depth from the wider end to zero depth near the narrower end.

2. The impeller of claim 1 wherein the conical body includes a tooth at the wider end that extends forward from each of the plurality of helical grooves.

3. The impeller of claim 1 wherein the plurality of helical grooves extend in a counterclockwise direction from the wider end toward the narrower end.

4. The impeller of claim 1 wherein the plurality of helical grooves extend in a clockwise direction from the wider end toward the narrower end.

5. The impeller of claim 1 wherein each of the plurality of helical grooves are elliptical grooves.

6. The impeller of claim 5 wherein each of the plurality of helical grooves has a forward edge and a trailing edge wherein a helical groove surface of the helical groove adjacent the forward edge is more concave than the helical groove surface of the helical groove adjacent the trailing edge.

7. The impeller of claim 1 wherein the front end and the back end have a mounting structure capable of permitting longitudinal, rotational movement of the conical body.

8. The impeller of claim 1 wherein the front end has a tapered conical surface that extends forward from the interface between the wider end of the conical body to a narrower front end a predefined distance forward from the wider end.

9. The impeller of claim 1 wherein the front end has a convex spherical surface having a height in the range greater than a flat planar surface and less than or equal to a hemisphere.

10. The impeller of claim 1 wherein the back end has a tapered conical surface that extends rearward from the interface between the narrower end of the conical body to a narrower back end a predefined distance rearward from the narrower end of the conical body.

11. The impeller of claim 1 wherein the back end has a convex spherical surface having a height in the range greater than a flat planar surface and less than or equal to a hemisphere.

12. The impeller of claim 1 further comprising a housing that contains the conical body.

13. The impeller of claim 12 wherein the housing has an inside surface that is cylindrically shaped.

14. The impeller of claim 12 wherein the housing has an inside surface that is conically shaped.

15. A method of forming a high efficiency impeller, the method comprising:
providing a conical body having a wider end, a narrower end and an outside body surface;
forming a plurality of helical grooves disposed in the outside body surface of the conical body wherein the helical grooves decrease in depth from the wider end to zero depth near the narrower end.

16. The method of claim 15 wherein the step of forming the plurality of helical grooves includes forming a plurality of elliptical and helical grooves.

17. The method of claim 16 wherein forming a plurality of elliptical and helical grooves includes providing a forward edge of the plurality of elliptical grooves that is more concave that a trailing edge of the plurality of elliptical grooves.
